(19) United States
(12) Patent Application Publication
(10) Pub. No.: US 2008/0106758 A1
(43) Pub. Date: May 8, 2008

(54) PRINT PROCESSING APPARATUS, CONTROL METHOD FOR PRINTING APPARATUS, AND COMPUTER READABLE STORAGE MEDIUM

(76) Inventor: Minako KAZUME, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/935,451

(22) Filed: Nov. 6, 2007

(30) Foreign Application Priority Data
Nov. 8, 2006 (JP) 2006-302626

(51) Int. Cl. G06F 15/00

(52) U.S. Cl. 358/1.15

(57) ABSTRACT

A print processing apparatus includes: a job information storage part that stores a print job ID and a number of pages finished printing regarding a print job processed by the print processing apparatus, a priority order information storage part that stores a priority order information regarding processing the print job corresponding to each of at least first and second host terminals, and a control part that issues the print job ID in a case of receiving the print data and stores the number of the pages and the print job ID in the job information storage part while processing the print job from the first host terminal. The control part processes a request for printing print data from the second host terminal and controls a processing of the print job of the first and second host terminals based on the priority order information, if the printing apparatus receives the request for printing from the second host terminal while processing the print job of the first host terminal.

### CROSS REFERENCE TO RELATED APPLICATIONS

This patent document claims the benefit of a Japanese Patent Application No. 2006-302626 filed Nov. 8, 2006 in the Japanese Patent Office, the entire disclosure of which is hereby incorporated herein by reference.

### BACKGROUND OF THE INVENTION

1. Field of the Invention

The present invention relates to a printing apparatus that appropriately processes a print request for printing new print data that is received during processing of current print data.

2. Description of the Background Art

A printing apparatus is shared with a plurality of terminal devices such as personal computers, word processors, server computers, host computers, and so on, through a network. In this situation, since each of the terminal devices is connected to the printing apparatus, the printing apparatus can print data from each of the devices.

Typically, on receiving print data from the terminal devices the printing apparatus processes the print data in the order that the print data is received, in spite of the amount of the data. Thereby, it may take a long time until the printing of print data for one terminal device that sent a print request to the printing apparatus if the printing apparatus is printing print data from another terminal device. In addition, when receiving a new print request during a current print processing, the printing apparatus cannot start the new print request until the current print processing is finished. So, the larger the amount of the currently processed print data, the longer it takes for the new print data to be finished, even if the amount of the new print data is less than that of the currently processed print data.

Among such printing apparatus, a network printer that stores print data sent from a client computer through a network and transmits the stored print data to another network printer in response to a requirement of the print data is proposed.

In addition, an information apparatus that transmits a print job through a network to an external device or system that is able to process the print job, instead of the information apparatus, in case of being not able to process the print job by itself is also proposed.

However, a suitable printing apparatus has not been proposed yet. In other words, those related arts have a problem that they cannot process appropriately a new request for processing print data that is sent from another terminal device when already processing print data from a first terminal device, and print out such data in an appropriate order.

### SUMMARY OF THE INVENTION

It is an object of the present invention to provide a novel and useful printing apparatus that can appropriately process printing requests from a plurality of terminal devices and print in an appropriate order during receiving print data.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows an example of a structure of a print processing apparatus to which the present invention can be applied.

FIG. 2 shows an example of print job information utilized in an embodiment of the present invention.

FIG. 3 shows an example of priority order information utilized in an embodiment of the present invention.

FIG. 4 shows an example of processing a print job by a print processing apparatus utilized in an embodiment of the present invention.

FIG. 5 shows an example of processing a print job by a print processing apparatus utilized in an embodiment of the present invention.

FIG. 6 shows an example of processing a print job by a print processing apparatus utilized in an embodiment of the present invention.

FIG. 7 shows an example of processing a print job by a print processing apparatus utilized in an embodiment of the present invention.

FIG. 8 shows an example of job cancel setting information utilized in an embodiment of the present invention.

### DETAILED DESCRIPTION OF PREFERRED EMBODIMENTS

A description will be given of embodiments of a printing apparatus, a control method for a printing apparatus, and a computer readable storage medium, by referring to the drawings, in which like reference characters indicate corresponding elements. In this embodiment, a printer 1 will be described as an example of the print processing apparatus.

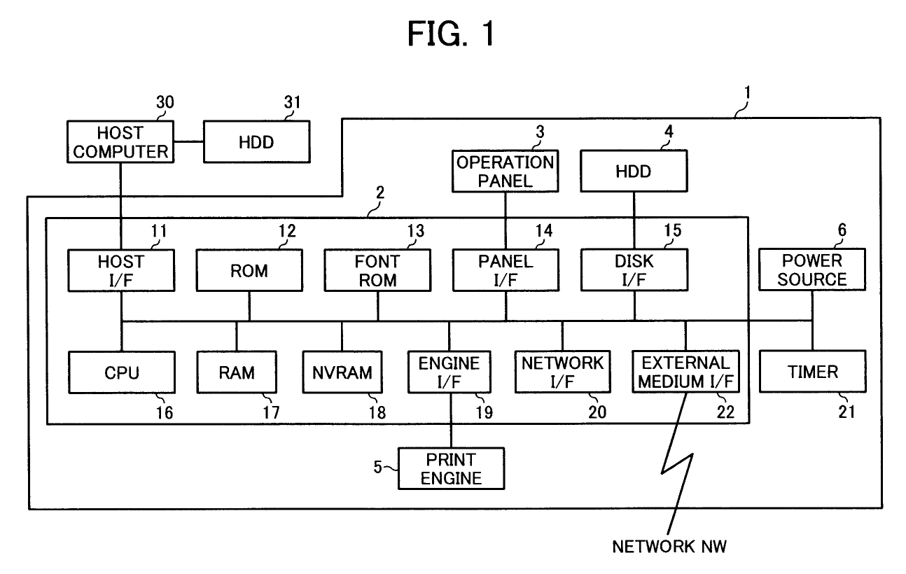

FIG. 1 shows an example of the structure of the printer 1. The printer 1 includes a controller 2, an operation panel 3, a hard disk drive (HDD) 4, a print engine 5, and a power source 6.

The controller 2 includes a host I/F 11, a ROM (Read Only Memory) 12, a font memory 13, a panel I/F 14, a disk I/F 15, a CPU 16, a RAM 17, a NVRAM 18, an engine I/F 18, a network I/F 20, and an external medium I/F 22. The printer 1 also includes a timer 21. The controller 2 controls print processing in the printer 1. That is, the controller 2 converts the print data received from host computer 30 to image data and outputs the image data to the print engine 5. Further, the controller 2 processes the print data as a print job.

The operation panel 3 receives a variety of operating instructions from an operator and displays a variety of information regarding the printer 1. The instructions are input through the panel I/F 14 and the variety of information are output through the panel I/F 14.

The HDD 4 stores a variety of data through the disk I/F 15. The disk I/F 15 operates as an interface with the HDD 4 and accesses the HDD 4 to write or read a variety of data.

The print engine 5 prints the image data output from the controller 2 on, e.g., printing paper through the engine I/F 19. In addition, the print engine 5 outputs a status signal indicating a completion of the print job of the host computer 30 to CPU 16 through the engine I/F 19. A known printer engine may be used for the print engine 5. The image processing technique used by the print engine 5 may be an electro-photography technique, an ink-jet technique, a thermal transfer technique, or any other appropriate technique.

The power source 6 supplies power to each part of the printer 1 according to an instruction of turning on the printer 1.

The host computer 30 connects to or includes a HDD 31. The HDD 31 stores document data created by the host computer 30, information regarding a print job ID, and the number of pages finished printing received from the printer 1. The document data and the information may also be stored in another storage device. The host computer 30 converts the document data into the print data that can be interpreted by the printer 1 and sends the print data to the printer 1. The host computer 30 sends a signal to the printer 1 that indicates a request for printing the print data. After receiving a notification from the printer 1 that indicates the print data from the host computer 30 is acceptable, the host computer 30 sends the print data to the printer 1. A plurality of host computers 30 are connectable to the printer 1 through the host I/F 11.

The host I/F 11 operates as an interface with the host computer 30 (or plural host computers 30). The printer 1 receives various signal such as the request for printing and the print data from the host computer 30 through the host I/F 11. Further, the printer 1 sends various information to the host computer 30 through the host I/F 11.

ROM 12 stores a program to control each module of the printer 1 and to process the print job. Further, ROM 12 stores a program to manage the print job.

The font memory 13 stores a variety of fonts used to print the print data sent from the host computer 30.

RAM 17 is used as a working memory for the CPU 16 and as a buffer memory storing the print data by page or image data generated from the print data.

NVRAM 18 stores a print job ID and the number of pages that have finished printing. The print job ID and the number of pages finished printing are stored corresponding to the print job of each host computer 30. Further, NVRAM 18 stores a priority order table including a relationship of a host computer name with a priority order. The priority order indicates the printing priority to control processing of the print data from a plurality of the host computers 30. A description regarding information stored in NVRAM 18 is described further below. In addition, NVRAM 18 may store a job cancel setting information also described further below.

CPU 16 processes the variety of data from the host computer 30 as a print job. In addition, CPU 16 controls each part in the printer 1 and the print processing, described further below.

The network I/F 20 operates as an interface with a network such as a LAN (Local Area Network), an Internet, etc. and receives a variety of information from an external device through the network. Further, the network I/F 20 sends a variety of information to the external device through the network. The external device may be the same computer as the host computer 30. In addition, the host I/F 11 and the network I/F 20 may be a single I/F.

The timer 21 is used by CPU 16 to check a waiting time to receive the print data from the host computer 30, described further below.

The external storage medium I/F 22 is used to install an external storage medium storing a computer program of the present invention such as a Secure Digital (SD) memory card, a Compact Flash (registered trademark), a Universal Serial Bus (USB) memory, a USB hard disk, or other appropriate detachable recording medium.

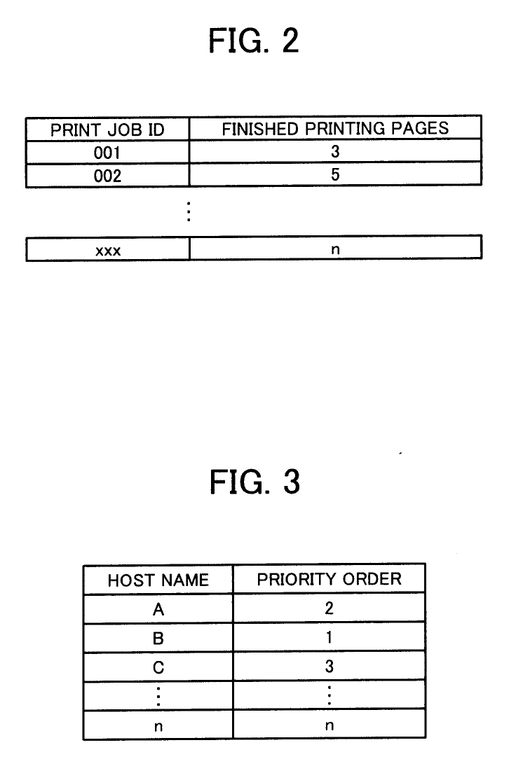

FIG. 2 shows an example of the print job ID and the number of pages finished printing stored in the NVRAM 18. In the example of FIG. 2, a value “001” as the print job ID and “3” as the number of pages finished printing of job ID “001” are stored. In addition, a value “002” as the print job ID and “5” as the number of pages finished printing of the print job 002 are stored. Further, other print job IDs and finished printing pages are stored, as indicated by a value “xxx” as the print job ID and “n” as the number of pages finished printing of job ID “xxx”. The information in FIG. 2 is stored in NVRAM 18 and indicates a relationship of the job ID with the number of pages finished printing corresponding to the print job. The job ID is issued in processing by the CPU 16 when the printer 1 receives the print data from host computer 30 or an external device. In addition, the number of pages finished printing is monitored by the CPU 16. Though the relationship of stored data in FIG. 2 is described as a list, it may be described in other ways, such as a given structured document such as XML (Extensible Markup Language).

FIG. 3 shows an example of priority order information to control the print jobs of a plurality of host computers 30, which can also be stored in NVRAM 18. In FIG. 3, the host computer 30 name and the priority order of the print job are stored. For example, the host computer whose host name is “A” has a second priority order, the host computer whose host name has “B” has a first priority order, the host computer whose host name has “C” has a third priority order, and the host computer whose host name is “n” has an “n”th priority order. Therefore, in this embodiment, the printing process of the host “B” is given priority to others generally. A relationship of the host name with the priority order of printing may be stored in NVRAM 18 in advance or modified in a desired case.

According to the priority order, the printer 1 can control the order of the printing processing. The host name may be a value that distinguishes each host computer and may be a computer name, MAC address, IP address, or other distinguishing indicator.

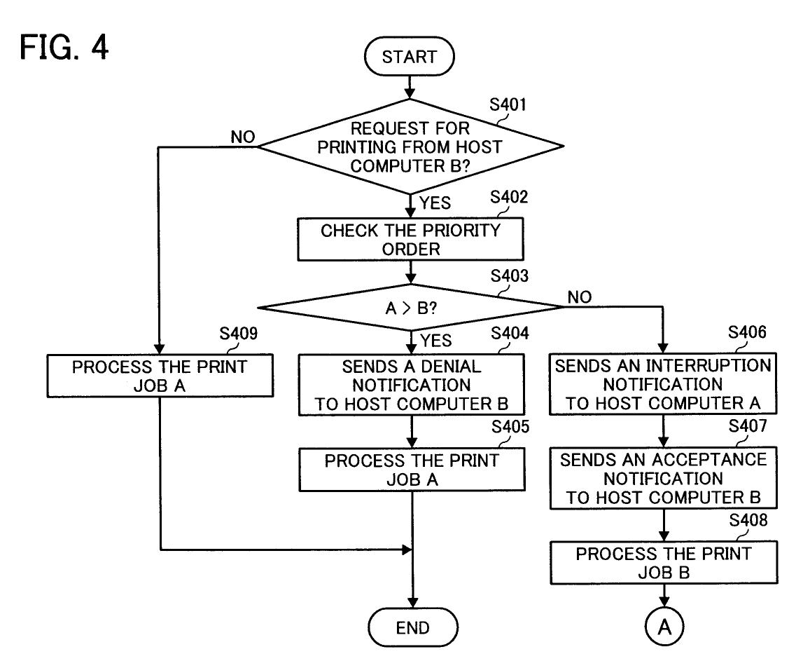

FIG. 4 shows an example of processing print jobs in a case that the printer 1 receives a request for printing print data from a second host computer 30 while printing print data of a first host computer 30. For convenience of description, the first host computer 30 will be referred to “host computer A” and the second host computer 30 will be referred to as “host computer B”. In addition, it is assumed the print job ID for the host computer A as a print job A has been issued by CPU 16.

At step S401, CPU 16 confirms through the host I/F 11 or the network I/F 20 whether the request for printing from the host computer B is received while the printer 1 is receiving or printing the print data from the host computer A. If CPU 16 does not recognize receiving a request for printing from the host computer B, No in step S401, the printer 1 keeps processing the print job A, at step S409. The CPU 16 then counts the number of pages finished printing of the print job of the host computer A and stores the count in NVRAM 18. On the other hand, if CPU 16 recognizes a request for printing print data from the host computer B, Yes in S401, the process proceeds to a next step S402.

At step S402, CPU 16 checks the priority order information. For example, CPU 16 refers to the priority order information between the host computer A and B stored in NVRAM 18, and compares both priority order information.

At step S403, CPU 16 confirms which priority order is higher. Regarding the host computers A and B, since in the example in FIG. 3 the priority order information of the host computer A is “2” and that of the host computer B is “1”, CPU 16 recognizes the smaller number as the higher priority order. Thus, the process proceeds to a next step S404 if the priority order of the host computer A is higher than that of B, if Yes in step S403. On the other hand, if CPU 16 recognizes the priority order of the host computer B is higher than that of A, if No in step S403, the process proceeds to step S406. Thereby, step S403 confirms which priority order is lower.

At step S404, since the priority order of the host computer A is higher than that of host computer B, CPU 16 sends a denial notification, indicating the request for printing the print data is denied, to the host computer B through the host I/F 11 or the network I/F20. The process then proceeds to step S405.

At step S405, CPU 16 continues to process the print job A, and CPU 16 continues to count the number of pages finished printing and stores the number into NVRAM 18. The process then ends.

At step S406, since the priority order of the host computer B is higher than that of host computer A, CPU 16 sends the host computer A an interruption notification indicating another print job interrupts the print job A and interrupts receiving the remaining print data from the host computer A. The process then proceeds to step S407.

At step S407, CPU 16 sends the host computer B an acceptance notification indicating the request for printing is acceptable and starts to receive the print data of the host computer B through the host I/F 11 or network I/F 20. The process then proceeds to step S408.

At step S408, CPU 16 issues the job ID for the host computer B as a print job B and stores the job ID in NVRAM 18. Further, CPU 16 starts to count the number of pages finished printing for print job B and stores it in NVRAM 18 for the print job B. The received print data is then converted to the image data and printed on the printing paper. Thus, the printer 1 processes the print data as the print job B. After step S408, the process proceeds to a next phase “A” described below.

With the above operations, if the printer 1 receives the request for printing the print data from the host computer B while processing the print job A, the printer 1 can control whether to accept the request for printing or continue to process the print job of the plural host computers A and B based on the priority order information.

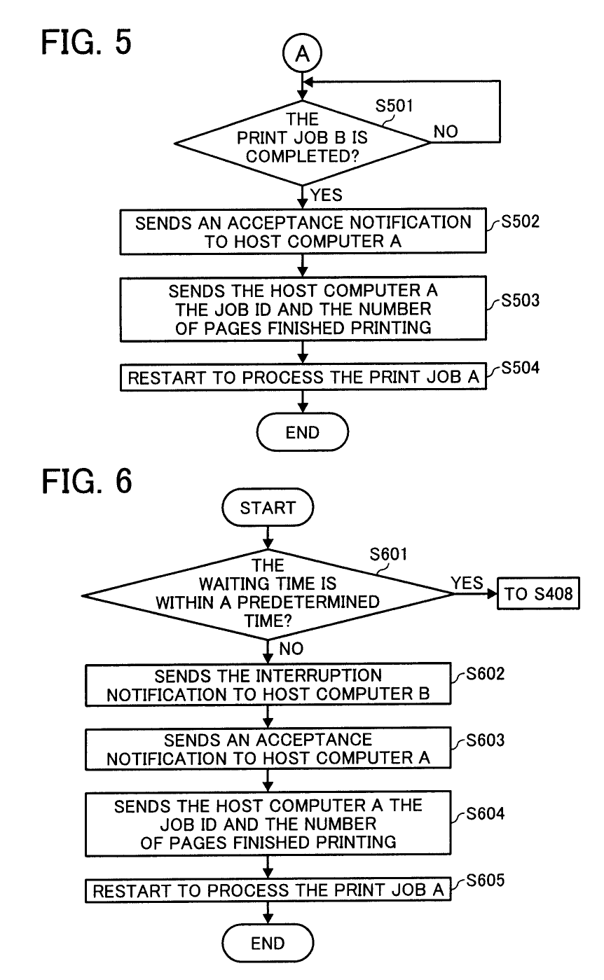

FIG. 5 shows processing after step S408 in FIG. 4, and shows an example of processing the print job B and an operation after finishing the print job B. This process is the continuation of the “A” as shown in FIG. 4.

At step S501, CPU 16 confirms whether the print job B is completed. For example, CPU 16 detects the completion signal from the print engine 5 through the engine I/F 19. If CPU 16 recognizes the print job B is not completed, No in step S501, CPU 16 continues to process the print job B. On the other hand, if CPU 16 recognizes the print job B is completed, Yes in step S501, the process proceeds to a next step S502.

At step S502, CPU 16 sends the host computer A a notification indicating the print job B is completed and the printer 1 can accept the remaining print data from the host computer A. The process then proceeds to step S503.

At step S503, CPU 16 sends the job ID for the host computer A and the number of pages finished printing stored in NVRAM 18 to the host computer A. Receiving the job ID and the number of pages finished printing, the host computer A starts to send the remaining pages corresponding to the job ID, that is, the host computer A then sends the pages still to be printed continuing from the pages finished printing, to the printer 1. The process then proceeds to step S504.

At step S504, CPU 16 restarts to process the print data sent from the host computer A as the print job A and stores the number of pages finished printing continuously. Finishing the print job A, the process ends.

As a modification of the above operations, at step S406, the CPU 16 may send the print job ID for the host computer A and the number of pages finished printing to the host computer A and store the number of pages finished printing of the host computer A in NVRAM 18 as an alternative step. According to the alternative step, the host computer A may send the remaining print data in response to step S502 and CPU 16 may skip a process at step S503.

With the further above operations, the printer 1 can easily and efficiently restart to process the print job A that is interrupted based on the stored job ID and stored number of pages finished printing.

FIG. 6 shows another example of processing the print jobs A and B from the host computers A and B. In FIG. 6, it is assumed the printer 1 is configured to store a waiting time to actually receive the print data after sending an acknowledgement indicating print data is acceptable to a host computer. In this embodiment, the process may be conducted as a sub-routine of step S407 as shown in FIG. 4.

As noted above, the printer 1 in this embodiment operates in the following manner. If for example the host computer B makes a request for a print job, the CPU 16 will receive that request and then provide an acknowledgement back to the host computer B that the request is proper and can proceed. The host computer B will then send the print data back to the CPU 16 in response to that acknowledgement, and the CPU 16 will then process that print data and control the other elements to print out that print data.

In this situation the CPU 16 will have to await the print data from the host computer B after it is indicated that it is acceptable to provide the print data. However, situations may arise such that after receiving the acknowledgement from the CPU 16 that it is acceptable to send the print data to the CPU 16, the host computer B may have a malfunction or for some other reason will not actually send the print data back to the CPU 16.

The operation in FIG. 6 addresses such a situation and ensures that the CPU 16 is then not unnecessarily inefficiently merely waiting for the print data from the host computer B. To address that situation the printer 1 will have a waiting time after it sends an acknowledgement signal to a host computer after which it will cancel that acknowledgement. In the example noted above, if the host computer B does not return the actual print data back to the printer 1 within a specific waiting time, the printer 1 will cancel the acknowledgement that it is acceptable for the host computer B to send such print data, and then the printer can go ahead and process other awaiting print data.

As noted above, the embodiment in FIG. 6 can be a sub-routine of step S407 as shown in FIG. 4, and thereby if in that embodiment the host computer B does not send the print data back to the printer 1 within the waiting time, the printer can then proceed to process the print data from the host computer A that was previously interrupted, as now discussed below.

At step S601, CPU 16 confirms whether the waiting time is within a predetermined time by checking the timer 21. If the print data is sent from the host computer B within the waiting time, Yes in step S601, the process proceeds to step S408 as shown in FIG. 4 and operations are conducted in the same manner as described above. On the other hand, if CPU 16 recognizes the print data is not sent from the host computer B within the waiting time, No in step S601, the process proceeds to a next step S602.

At step S602, CPU 16 sends the interruption notification indicating receiving the print data is interrupted to the host computer B. The process then proceeds to step S603.

At step S603, CPU 16 sends the host computer A the acceptance notification that the printer 1 can accept the remaining print data from the host computer 1. The process then proceeds to step S604.

At step S604, CPU 16 sends the job ID for the host computer A and the number of pages finished printing to the host computer A. Receiving them, the host computer A starts to send the remaining pages corresponding to the job ID, that is, the pages still to be printed continuing from the pages finished printing, to the printer 1. The process then proceeds to step S605.

At step S605, CPU 16 restarts to process the print data sent from the host computer A as the print job A and stores the number of pages finished printing continuously. Finishing the print job A, the process ends.

At step S406, CPU 16 may send the print job ID for the host computer A and the number of pages finished printing to the host computer A and store the number of pages finished printing of the host computer A in NVRAM 18 as an alternative step, as described above. According to the alternative step, the host computer A may send the remaining print data in response to step S603 and CPU 16 may skip the process at step S604.

With the operations noted above, the printer 1 can interrupt processing of the print data that is not sent within the waiting time and process the print job of another host computer.

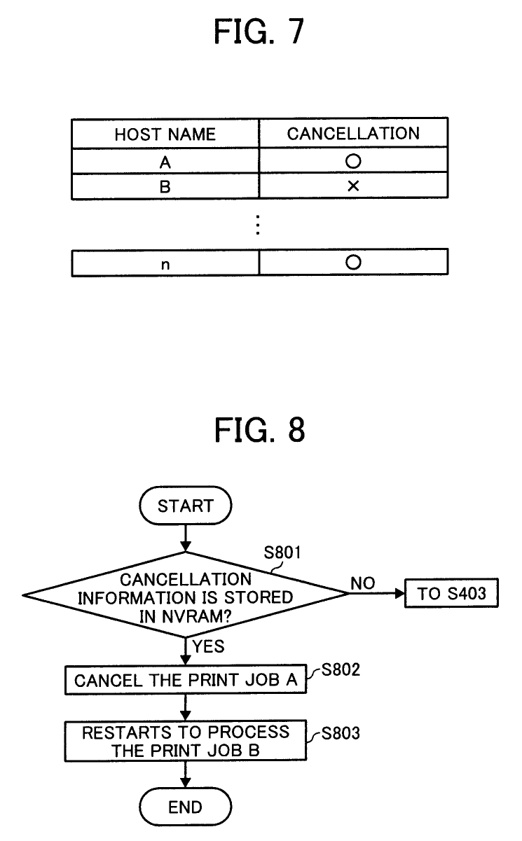

FIG. 7 shows a modification or additional processing that can be implemented in the present invention. FIG. 7 shows a relationship with the host computer and cancellation information, i.e., whether the host computer cancels the print job under processing or not, in a case the printer 1 receives the request for printing the print data from another host computer B while processing the print job of the host computer A. A relationship with the host computer and the job cancellation information is stored in NVRAM 18. In the example in FIG. 7, the host computers A and n are configured to cancel a print job under processing (indicated by the “◯”), but the host computer B is not configured to cancel a print job under processing (indicated by the “x”). It is possible to configure such relationships through the operation panel 3 by the user.

FIG. 8 shows processing of print jobs according to the print job cancellation information regarding the host computers A, B as shown in FIG. 7. The cancellation process continues after step 402 as shown in FIG. 4.

At step S801, CPU 16 confirms whether the cancellation configuration information is stored in NVRAM 18. If CPU 16 recognizes the cancellation configuration information is not stored in NVRAM 18, No in step S801, the process proceeds to step S403 and continues to process through step S406 as described above. On the other hand, if CPU 16 recognizes the cancellation configuration information is stored in NVRAM 18, Yes in step S801, the process proceeds to a next step S802.

At step S802, CPU 16 cancels the print job A under processing and proceeds to a next step S803.

At step S803, CPU 16 starts to process the print job B. Further, CPU 16 counts the number of pages finished printing and stores the number into NVRAM 18. Completing the print job B, the process ends.

On the other hand, regarding the print job B, CPU 16 continues to process the print job B without canceling.

With the above operations, the printer 1 can control whether to cancel the print job under processing according to the stored print job cancellation information.

A computer readable storage medium according to the present invention causes a computer to carry out the processes described above. More particularly, the computer readable storage medium stores a computer program that causes the computer to operate as a printing apparatus such as the printer 1 described above. The effects of the embodiments described above can be obtained by the computer readable storage medium.

The computer readable program may be prestored in a storage part within the computer, such as the ROM and the HDD. On the other hand, the computer readable program may be stored in a non-volatile recording medium or memory, such as a CD-ROM, flexible disk, a SRAM, an EEPROM, a memory card, a magnetic recording medium, an optical recording medium, a magneto-optical recording medium, etc. The computer-readable program stored in the non-volatile recording medium or memory may be installed into the computer and executed by the CPU, or the CPU may read the computer-readable program from the non-volatile recording medium or memory and execute the computer-readable program, so as to realize the functions of any of the embodiments and modifications described above.

Of course, the computer-readable program may be executed by downloading the computer-readable program from an external equipment that is provided with a recording medium recorded with the computer-readable program, or from an external equipment having a storage part or means stored with the computer-readable program.

Obviously, numerous additional modifications and variations of the present invention are possible in light of the above teachings. It is therefore to be understood that within the scope of the appended claims, the invention may be practiced otherwise than as specifically described herein.

1. A print processing apparatus comprising:
a job information storage part configured to store a print job ID and a number of pages finished printing regarding respective print jobs processed by the print processing apparatus;
a priority order information storage part configured to store priority order information regarding processing of the print jobs corresponding to each of host terminals that can output print data to be printed;
a control part configured to issue the print job ID in a case of receiving the print data and to store the number of the pages finished printing and the print job ID in the job information storage part while processing the print job from a first host terminal;
wherein the control part processes a request for printing print data from a second host terminal and controls a processing of the print job of the first and second host terminals based on the priority order information, if the printing apparatus receives the request for printing the print data from the second host terminal while processing the print job of the first host terminal.

2. The print processing apparatus as claimed in claim 1, wherein the control part notifies the second host terminal that the print processing apparatus denies the request for printing the print data of the second host terminal and continues to process the print job of the first host terminal, if the priority order information of the first host terminal is higher than that of the second host terminal.

3. The print processing apparatus as claimed in claim 1, wherein the control part accepts the request for printing the print data of the second host terminal and notifies the first host terminal that the print job of the first host terminal is interrupted by the print job of the second host terminal, if the priority order information of the first host terminal is lower than that of the second terminal.

4. The print processing apparatus as claimed in claim 3, wherein after finishing the print job of the second host terminal, the control part notifies the first host terminal that the request for printing the print data of the first host terminal is acceptable and sends the print job ID and the number of the pages finished printing regarding the print job interrupted by the second host terminal to the first host terminal.

5. The print processing apparatus as claimed in claim 3, wherein the control part notifies the second host terminal that the request for printing is canceled if the print data of the second host terminal is not received within a predetermined time.

6. The print processing apparatus as claimed in claim 5, wherein the control part notifies the first host terminal that the request for printing the print data of the first host terminal is acceptable and sends the print job ID and the number of the pages finished printing regarding the print job interrupted by the second host terminal to the first host terminal.

7. The print processing apparatus as claimed 1, wherein the job information storage part further stores a job cancellation information corresponding to each host terminal, which indicates whether to cancel the print job under processing, and the control part controls whether to cancel the print job under processing according to the stored job cancellation information.

8. A print processing apparatus comprising:
a job information storage means for storing a print job ID and a number of pages finished printing regarding respective print jobs processed by the print processing apparatus in a storage unit;
a priority order information storage means for storing priority order information regarding processing of the print jobs corresponding to each of host terminals that can output print data to be printed;
a control means for issuing the print job ID in a case of receiving the print data and for storing the number of the pages finished printing and the print job ID in the storage unit while processing the print job from a first host terminal;
wherein the control means processes a request for printing the print data from a second host terminal and controls a processing of the print job of the first and second host terminals based on the priority order information, if the printing apparatus receives the request for printing the print data from the second host terminal while processing the print job of the first host terminal.

9. The print processing apparatus as claimed in claim 8, wherein the control means notifies the second host terminal that the print processing apparatus denies the request for printing the print data of the second host terminal and continues to process the print job of the first host terminal, if the priority order information of the first host terminal is higher than that of the second host terminal.

10. The print processing apparatus as claimed in claim 8, wherein the control means accepts the request for printing the print data of the second host terminal and notifies the first host terminal that the print job of the first host terminal is interrupted by the print job of the second host terminal, if the priority order information of the first host terminal is lower than that of the second terminal.

11. The print processing apparatus as claimed in claim 10, wherein after finishing the print job of the second host terminal, the control means notifies the first host terminal that the request for printing the print data of the first host terminal is acceptable and sends the print job ID and the number of the pages finished printing regarding the print job interrupted by the second host terminal to the first host terminal.

12. The print processing apparatus as claimed in claim 10, wherein the control means notifies the second host terminal that the request for printing is canceled if the print data of the second host terminal is not received within a predetermined time.

13. The print processing apparatus as claimed in claim 12, wherein the control means notifies the first host terminal that the request for printing the print data of the first host terminal is acceptable and sends the print job ID and the number of the pages finished printing regarding the print job interrupted by the second host terminal to the first host terminal.

14. The print processing apparatus as claimed 8, wherein the job information storage means further stores a job cancellation information corresponding to each host terminal in the storage unit whether to cancel the print job under processing, and the control means controls whether to cancel the print job under processing according to the stored job cancellation information.

15. A control method for a print processing apparatus comprising:
storing a print job ID and a number of pages finished printing regarding a print job processed by the print processing apparatus, in a storage unit;
storing a priority order information regarding processing the print job corresponding to each of at least first and second host terminals that can output print data, in the storage unit;
issuing the print job ID in a case of receiving the print data and storing the number of the pages finished printing corresponding to the issued print job ID in the storage unit while processing the print job from the first host terminal; and
processing a request for printing the print data from the second host terminal and controlling a processing of the print job of the first and second host terminals based on the priority order information, if the printing apparatus receives the request for printing the print data from the second host terminal while processing the print job of the first host terminal.

16. A computer readable storage medium which stores a computer program to cause a computer to perform a process, the process comprising:
storing a print job ID and a number of pages finished printing regarding a print job processed by the print processing apparatus, in a storage unit;
storing a priority order information regarding processing the print job corresponding to each of at least first and second host terminals that can output print data, in the storage unit;
issuing the print job ID in a case of receiving the print data and storing the number of the pages finished printing corresponding to the issued print job ID in the storage unit while processing the print job from the first host terminal; and
processing a request for printing the print data from the second host terminal and controlling a processing of the print job of the first and second host terminals based on the priority order information, if the printing apparatus receives the request for printing the print data from the second host terminal while processing the print job of the first host terminal.
